(19) United States
(12) Patent Application Publication
(10) Pub. No.: US 2009/0239725 A1
(43) Pub. Date: Sep. 24, 2009

(54) METHOD AND SYSTEM FOR ASSOCIATING AN INSERT WITH A CARTON

(76) Inventors: Edward J. Cook, Toronto (CA); Edward Paterson, Toronto (CA)

Correspondence Address: SMART & BIGGAR, 438 UNIVERSITY AVENUE, SUITE 1500, BOX 111, TORONTO, ON, M5G 2K8, CA

(21) Appl. No.: 12/052,176

(22) Filed: Mar. 20, 2008

(51) Int. Cl. B31B 15/26

(52) U.S. Cl. 493/111

(57) ABSTRACT

To associate a paper insert with a carton, a first identifier (such as identifying indicia) is read from the insert and a second identifier is read from the carton blank. A determination is made whether the first identifier and the second identifier indicate the paper insert is properly matched with the carton blank. If yes, the paper insert is affixed to the carton blank and the carton blank is folded around the insert and its margins glued together to form a flat sleeve surrounding the insert. If no, the mismatch may be indicated.

### BACKGROUND

This invention relates to an approach to associate an insert with a carton.

Pharmaceuticals are sold with instructions for their use. Often these instructions are in the form of a folded leaflet stuffed into a carton holding the pharmaceutical. For example, a bottle of pills, with a leaflet bent around it, may be packaged in a carton. To manufacture such a product, the bottle of pills may be pushed toward the open mouth of the carton against the middle of the unbent leaflet, which leaflet is positioned to extend across the open mouth of the carton. This causes the leaflet to bend around the bottle of pills as the bottle is pushed into the carton. After the bottle of pills and bent leaflet have been pushed into the carton, the carton may be sealed closed.

A drawback with this approach is that the speed of manufacture is limited in order to avoid damage to the leaflet or carton during insertion. In this regard, a typical speed of manufacture using this approach is on the order of 6,000 cartons per hour. Further, recurrent jams are a problem.

This invention seeks to overcome drawbacks with prior approaches to packaging a leaflet relating to a product with the product and, in particular, with prior approaches to packaging a leaflet relating to a pharmaceutical with the pharmaceutical.

### SUMMARY

To associate a paper insert with a carton, a first identifier (such as identifying indicia) is read from the insert and a second identifier is read from the carton blank. A determination is made whether the first identifier and the second identifier indicate the paper insert is properly matched with the carton blank. If yes, the paper insert is affixed to the carton blank and the carton blank is folded around the insert and its margins glued together to form a flat sleeve surrounding the insert. If no, the mismatch may be indicated.

In accordance to the present invention, there is provided a method of associating an insert with a carton comprising: reading a first identifier from a paper insert; reading a second identifier from a carton blank; determining whether said first identifier and said second identifier indicate said paper insert is matched with said carton blank; where said first identifier and said second identifier indicate said paper insert is matched with said carton blank, affixing said paper insert to said carton blank and folding said carton blank around said insert and gluing a margins of said carton blank together to form a flat sleeve surrounding said insert.

In accordance with another aspect of the present invention, there is provided a system for associating an insert with a carton, comprising: a carton blank feeder for feeding printed carton blanks, said carton blank feeder having, in downstream order, a first zone and a second zone, said second zone for folding over and gluing each carton blank into a flat sleeve; a gluer at said first zone for depositing glue on said each carton blank; a carton identifier reader at said first zone for reading a carton identifier from said each carton blank; an insert feeder for feeding a paper insert having an insert identifier onto each carton blank downstream of said gluer and downstream of said carton identifier reader; an insert identifier reader associated with said insert feeder for reading said insert identifier on each insert; at least one sensor for sensing a speed and position of said each carton blank; a controller operatively connected to said carton identifier reader, said insert identifier reader, said at least one sensor, and said insert feeder, said controller for receiving a read identifier from a given carton blank, for receiving a read identifier from a given insert to be fed to said given carton blank, for determining whether each said read identifier indicates said paper insert is properly matched with said carton blank, and, at least where said read identifier indicates said paper insert is properly matched with said carton blank, operating said insert feeder to dispense said insert onto said carton blank.

In accordance with a further aspect of the present invention, there is provided a system for associating an insert with a carton, comprising: a carton blank feeder for feeding printed carton blanks, said carton blank feeder having, in downstream order, a first zone and a second zone, said second zone for folding over and gluing each carton blank into a flat sleeve; a gluer at said first zone for depositing glue on said each carton blank; a carton identifier reader at said first zone for reading a carton identifier from said each carton blank; an insert feeder for feeding a paper insert bearing indicia onto each carton blank downstream of said gluer and downstream of said carton indicia reader; an insert identifier reader associated with said insert feeder for reading an insert identifier on each insert; at least one sensor for sensing a speed and position of said each carton blank; a controller operatively connected to said carton indicia reader, said insert identifier reader, and said at least one sensor, said controller for receiving a read identifier from a given carton blank, for receiving a read identifier from a given insert to be fed to said given carton blank and for, where each said read identifier indicate said paper insert is not matched with said carton blank, indicating said mismatch.

Other features and advantages will become apparent from the following description in conjunction with the drawings.

### BRIEF DESCRIPTION OF THE DRAWINGS

In the figures which illustrate an example embodiment of this invention,

FIG. 1 is a schematic diagram of a system made in accordance with this invention, and

FIGS. 2A and 2B are diagrams illustrating the progression of a product moving through the system of FIG. 1.

### DETAILED DESCRIPTION

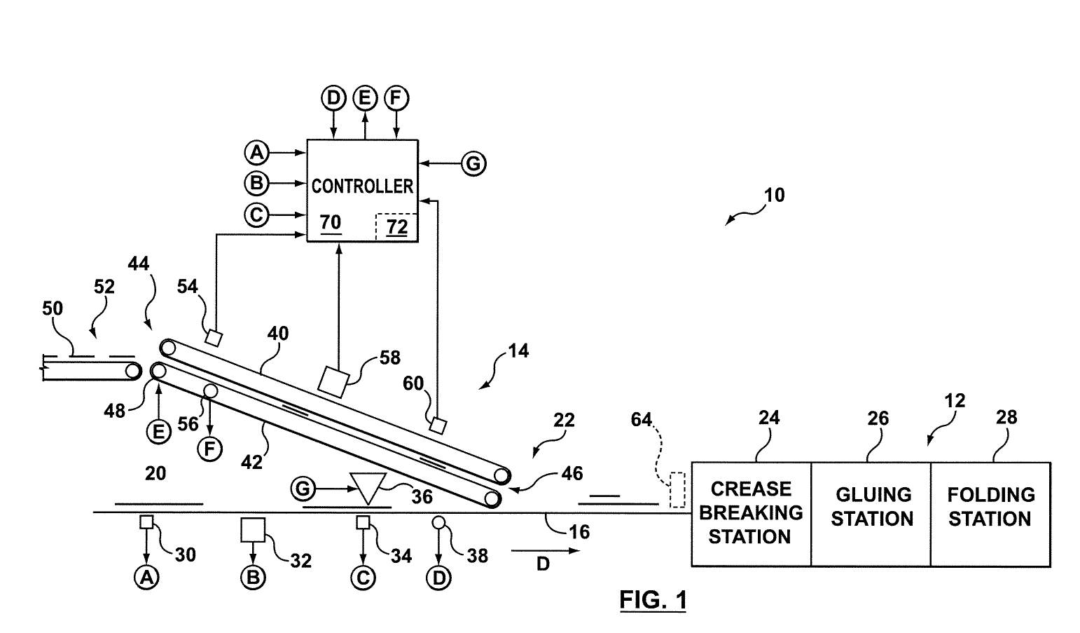

With reference to FIG. 1, an exemplary feeding system 10 has a carton blank feeder 12 and an insert feeder 14. The carton blank feeder 12 has a carton blank conveyor 16 for conveying carton blanks 20. The conveyor 16 has, in downstream order, D, a first, open, zone 22, a crease breaking station 24, a gluing station 26, and a folding station 28. The open zone 22 has associated with it, in downstream order, a first photocell 30, a bar code reader 32, a second photocell 34, a glue gun 36, and a rotary encoder 38. Optionally, the open zone may also have a kicker 64 associated with it. A suitable carton blank feeder 12, absent the additional components associated with the open zone 22, is available from Bobst SA under the name ALPINA 2™. With this Bobst feeder, the open zone 22 is an alignment zone to laterally align the carton blanks.

Insert feeder 14 is a pair of parallel pinch belts 40, 42 declining from an input end 44 to an output end 46 adjacent the carton blank feeder 12 at its open zone 22. The belts are geared together and run by a motor 48. An insert store 52 supplies the insert feeder 14 with inserts 50. The insert feeder has associated with it, in downstream order, a first photocell 54, a rotary encoder 56, a bar code reader 58, and a second photocell 60.

A controller 70 is input with an output signal from each of the photocell 30, bar code reader 32, second photocell 34, glue gun 36, and rotary encoder 38 associated with the open zone 22 of the carton blank feeder 12 and with the photocell 54, rotary encoder 56, bar code reader 58, and photocell 60 of the insert feeder 14. The controller also outputs a control signal to the feeder motor 48 and to an alarm 62. The controller operates under the control of software from memory 72.

The carton blank feeder 12 is operated independently of the insert feeder 14: the controller 70 does not control the speed of the carton blank feeder 12 nor the spacing of the carton blanks 20 on conveyor 16, which spacing may be variable.

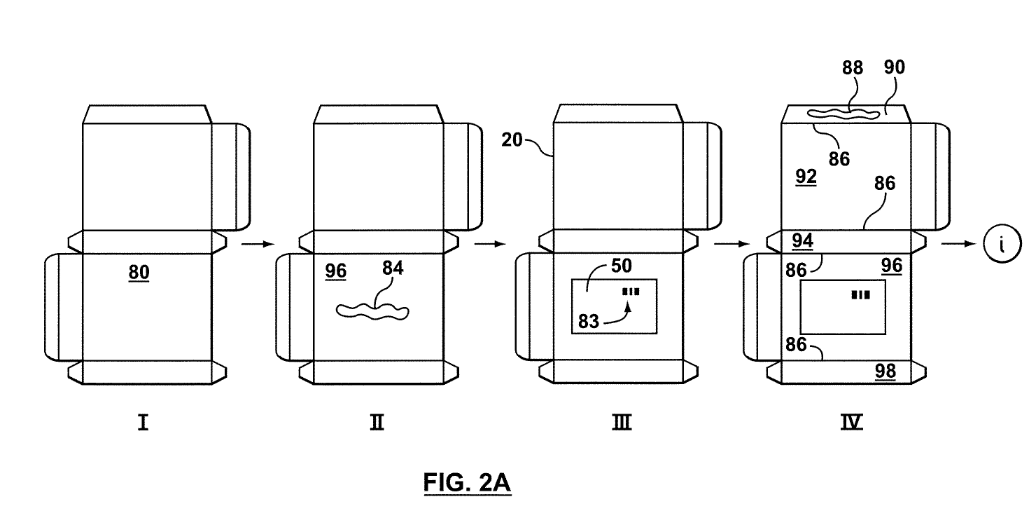

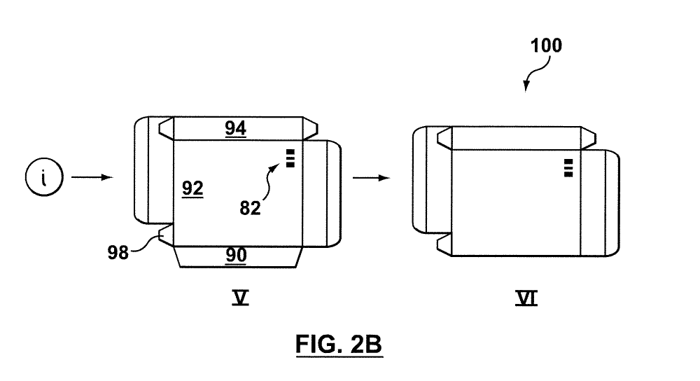

Carton blanks are fed with the surface 80 (FIG. 2A) which will form the inside of a carton formed from the blank facing upwardly and the surface which will form the outside of the carton facing downwardly. This downwardly directed face bears indicia, including a bar code 82 (FIG. 2B). Photocell 30 senses the leading edge of each carton blank 20 as the blank passes over the eye and sends a “blank sensed” signal to controller 70. Photocell 34 operates in an identical fashion. Bar code reader 32 reads the bar code on the downward facing surface of the carton blank 20 and sends an indication of this bar code to the controller. Rotary encoder 38 senses the speed of the conveyor 16 and sends a speed signal to the controller.

With the carton blank location signals and conveyor speed signal, the controller can track the position of each carton blank on conveyor 16. One consequence of this is that the controller can send a control signal to operate gluer 36 whenever a carton blank is properly positioned under the gluer in order to dispense a line 84 (FIG. 2A) of glue onto the carton blank.

Inserts 50 are fed to the input end 44 of insert feeder 14 by insert store 52. The controller 70 sends a control signal to motor 48 of the insert feeder 14 to control the speed of insert feeder 14. Photocell 54 senses the leading edge of each insert 50 as the insert passes over the photocell and sends an “insert sensed” signal to controller 70. Photocell 60 operates in an identical fashion. Bar code reader 58 reads the bar code 83 (FIG. 2A) on the upper face of the insert 50 and sends an indication of this bar code to the controller. Rotary encoder 56 senses the speed of the insert feeder 14 and sends a speed signal to the controller.

With the insert location signals and insert feeder speed signal, the controller can track the position of each insert in feeder 14.

The controller will know that the insert which is most advanced within insert feeder 14 will be the insert which can be fed onto the next carton blank that will pass the output end 46 of the insert feeder. The controller will also have identified this most advanced insert and the carton blank onto which it may be fed by their respective bar codes. Through this identification, the controller determines if the insert is intended to be matched with the carton. Assuming that the most advanced insert is properly matched with the next carton blank which will reach output end 46 of the insert feeder, the controller controls the speed of the insert conveyor to ensure this most advanced insert is dispensed onto the glue line of this next carton blank as it passes output end 46. Further, the controller controls the speed profile of the insert conveyor during dispensing of the insert so that the speed of the insert matches that of the carton blank onto which it is dispensed.

If the controller determines that the most advanced insert is not properly matched with the next carton blank that will reach the output end 46 of the insert feeder, the controller can stop the insert feeder and activate alarm 62. Alternatively, if a kicker 64 is installed on conveyor 16 downstream of the output end 46 of the insert feeder, the controller can allow the mismatched insert to be married to the carton blank, but signal the kicker (at an appropriate moment) to kick the blank with mismatched insert off the conveyor 16, or at least out of registration so that it can be plucked off the line at a downstream point. The controller could determine that the insert is not properly matched with the carton blank either because (i) the bar code read from the insert and the bar code read from the carton blank to which it will be married show a mismatch or (ii) the bar code signal from one of readers 32 and 58 shows a reading error. The first situation is a far more serious problem such that stopping the line may be the appropriate response. With the second situation, it may be more appropriate to simply kick the affected blank with its attached insert off the line.

FIGS. 2A and 2B illustrate the progression of a carton blank 20 through the carton blank feeder 12. At the upstream end of open zone 22, the carton blank appears as shown at I. As shown at II, after passing gluer 36, panel 96 of the blank has a line of glue 84. Once the blank has passed the output end 46 of the insert feeder 14, as seen at III, an insert 50 is affixed to the blank 20 over the line of glue. At the crease breaking station 24, the blank is partially folded at a number of its crease lines 86 in order to break these lines. As shown at IV, at gluing station 26, a line 88 of glue is dispensed onto panel 90 of the blank. Then, at folding station 28, panels 90, 92, and 94 are folded over panel 96—to which the insert is attached—and panel 98. The result is seen at V. Lastly, as shown at VI, glue bearing panel 90 is folded under panel 98 and adhered to panel 98. This forms a flat sleeve 100, with the insert inside the sleeve.

Possibly at a different facility, the flat sleeve may be knocked-up into a carton and filled with product.

With carton blank feeder 12 and insert feeder 14 operating in-line, it will be appreciated that the system 10 may be operated at high speed. Indeed, speeds of 30,000 carton blanks per hour, or more, may be achievable. Yet, nevertheless, with the described operation, it will be assured that the insert within the carton will be the insert which is intended for the carton. This is particularly important in the pharmaceutical industry where improper directions on use could, if followed, harm a user or lessen the efficacy of the pharmaceutical.

In the pharmaceutical industry, the carton insert is typically a folded leaflet. It will be appreciated that system 10 is able to accommodate the thickness presented by a folded leaflet.

Tracking accuracy by the controller is enhanced with the presence of two photocells associated with the insert feeder and two photocells associated with the carton blank feeder. However, it will be appreciated that the system will work with a single photocell associated with each of the insert feeder and the carton blank feeder.

It will be appreciated that each photocell 30, 34, 54, 60 could be replaced with any other suitable sensor as, for example, a CCD camera. Similarly, it will be appreciated that each rotary encoder 38, 56 could be replaced with any other speed sensor such as, for example, a video camera.

It may be that the insert and carton blank are printed with identifying indicia other than a bar code, in which case bar code readers 32, 58 would be replaced with a suitable indicia reader. For example, if the identifying indicia were text, it may be that the bar code readers would be replaced with optical character readers (OCRs). Yet further, each of the insert and carton blank could bear an identifier other than indicia, such as a radio frequency identification (RFID) tag, in which case the readers would be RFID readers.

While in the described operation, glue gun 36 operates based on a control signal from the controller, optionally, if photocell 34 is placed under (or just upstream) of the glue gun, the gun can be triggered directly from photocell 34.

While the insert feeder 14 has been described as being a pair of parallel pinch belts 40, 42, optionally, the insert feeder could instead be a lug conveyor, such as an overhead linear lug conveyor, or possibly a carrousel lug conveyor.

Other modifications will be apparent to those skilled in the art and, therefore, the invention is defined in the claims.

What is claimed is:

1. A method of associating an insert with a carton comprising:
reading a first identifier from a paper insert;
reading a second identifier from a carton blank;
determining whether said first identifier and said second identifier indicate said paper insert is matched with said carton blank;
where said first identifier and said second identifier indicate said paper insert is matched with said carton blank, affixing said paper insert to said carton blank and folding said carton blank around said insert and gluing a margins of said carton blank together to form a flat sleeve surrounding said insert.

2. The method of claim 1 wherein said reading a second identifier from a carton blank comprises reading identifying indicia from an outside face of said carton blank and wherein said affixing said insert to said carton blank comprises affixing said insert to an inside face of said carton blank.

3. The method of claim 2 further comprising tracking said carton blank while said carton blank is fed.

4. The method of claim 3 wherein said feeding said insert comprises feeding said insert at a variable speed dependent upon said tracking in order to feed said insert onto said carton blank.

5. The method of claim 4 wherein said tracking comprises tracking a speed of a conveyor conveying said carton blank and sensing said carton blank on said conveyor.

6. The method of claim 1 further comprising, where said first identifier and said second identifier indicate said paper insert is not matched with said carton blank, indicating said mismatch.

7. The method of claim 6 wherein said indicating a mismatch comprises stopping said insert feeder.

8. The method of claim 6 wherein said indicating a mismatch comprises raising an alarm.

9. The method of claim 6 wherein said indicating a mismatch comprises re-positioning said carton blank.

10. The method of claim 6 wherein said reading a second identifier from a carton blank comprises reading a bar code on an outside face of said carton blank.

11. The method of claim 10 wherein said reading a first identifier from a paper insert comprises reading a bar code on said paper insert.

12. The method of claim 1 wherein said affixing comprises applying glue to one of said insert and said carton blank and feeding said insert onto said carton blank.

13. The method of claim 5 wherein said affixing comprises applying glue to one of said insert and said carton blank and feeding said insert onto said carton blank.

14. A system for associating an insert with a carton, comprising:
a carton blank feeder for feeding printed carton blanks, said carton blank feeder having, in downstream order, a first zone and a second zone, said second zone for folding over and gluing each carton blank into a flat sleeve;
a gluer at said first zone for depositing glue on said each carton blank;
a carton identifier reader at said first zone for reading a carton identifier from said each carton blank;
an insert feeder for feeding a paper insert having an insert identifier onto each carton blank downstream of said gluer and downstream of said carton identifier reader;
an insert identifier reader associated with said insert feeder for reading said insert identifier on each insert;
at least one sensor for sensing a speed and position of said each carton blank;
a controller operatively connected to said carton identifier reader, said insert identifier reader, said at least one sensor, and said insert feeder, said controller for receiving a read identifier from a given carton blank, for receiving a read identifier from a given insert to be fed to said given carton blank, for determining whether each said read identifier indicates said paper insert is properly matched with said carton blank, and, at least where said read identifier indicates said paper insert is properly matched with said carton blank, operating said insert feeder to dispense said insert onto said carton blank.

15. A system for associating an insert with a carton, comprising:
a carton blank feeder for feeding printed carton blanks, said carton blank feeder having, in downstream order, a first zone and a second zone, said second zone for folding over and gluing each carton blank into a flat sleeve;
a gluer at said first zone for depositing glue on said each carton blank;
a carton identifier reader at said first zone for reading a carton identifier from said each carton blank;
an insert feeder for feeding a paper insert bearing indicia onto each carton blank downstream of said gluer and downstream of said carton indicia reader;
an insert identifier reader associated with said insert feeder for reading an insert identifier on each insert;
at least one sensor for sensing a speed and position of said each carton blank;
a controller operatively connected to said carton indicia reader, said insert identifier reader, and said at least one sensor, said controller for receiving a read identifier from a given carton blank, for receiving a read identifier from a given insert to be fed to said given carton blank and for, where each said read identifier indicate said paper insert is not matched with said carton blank, indicating said mismatch.
